(19) United States
(12) Patent Application Publication
(10) Pub. No.: US 2003/0190154 A1
(43) Pub. Date: Oct. 9, 2003

(54) Method and apparatus for data compression of multi-channel moving pictures

(76) Inventors: In-Keon Lim, Seoul (KR); Chul-Jin Jang, Seoul (KR); Do-Yeon Kim, Seoul (KR); Dong-Yeob Lee, Seoul (KR)

Correspondence Address: Volentine Francos, Suite 150, 12200 Sunrise Valley Drive, Reston, VA, 20191, US

(21) Appl. No.: 10/344,478

(22) PCT Filed: Jun. 14, 2002
(86) PCT No.: PCT/KR02/01118

(30) Foreign Application Priority Data
Jun. 15, 2001 (KR) 2001/33887

(51) Int. Cl. H04N 5/76

(52) U.S. Cl. 386/98; 386/111

(57) ABSTRACT

The present invention discloses a method and apparatus for compressing the data size of video image of moving pictures for multi-channel digital video recorders for security and surveillance system.

### FIELD OF THE INVENTION

The present invention relates to a data compression technique for multi-channel moving pictures, and more particularly to an efficient data storage system for moving pictures captured and transmitted from multi-channel digital video recorders.

### DESCRIPTION OF THE RELATED ART

Digital video recorders (DVRs) for the security and surveillance system should have functions both of data compressing the captured moving pictures for the storage and of decompressing the compressed data. The data compression can be implemented either through software or through hardware.

The software method relies on a scheme comprising steps of decoding the camera-captured analog image into a digital video signal and compressing the decoded digital video signal for the reduction of the data size.

The aforementioned software method has a shortcoming in a sense that the number of frames per second (fps) that can be processed is limited by the data processing capability of a central processing unit (CPU).

Several approaches have been proposed for overcoming the aforementioned prior art. One is the hardware method, which include JPEG, wavelet, MPEG, and H.263 for the data compression of digital video signals.

The JPEG and wavelet techniques are related to a data compression scheme for still images, and based upon the algorithm of simply arranging the compressed data of each still image.

Therefore, the compressed data for each still image according to JPEG or wavelet do not have correlation with each other and has a feature that each still image is compressed independently of the previous image.

In the meanwhile, the data compression technique according to the MPEG (moving pictures engineers group) employs the correlation between two neighboring frames in succession by estimating the difference of the two.

In other words, since the MPEG scheme relies on an approach that only the difference between the image frame in succession and the reference frame is considered, the image frame in succession can be restored as long as the image data of the prior frame is available.

The data compression technique for moving pictures according to the traditional MPEG scheme, however, has a limit for the application of the multi-channel DVR system because the data compression rate becomes poor.

More specifically, since a frame at time t of the n-th channel is compressed with reference to the preceding frame at time (t−1) of the (n−1)-th channel in case when only one MPEG compression chip is employed, the efficiency for the data compression will become inevitably poor for the multiple channels of moving pictures.

In other words, since each MPEG chip has only one terminal for video input and compresses the video data by estimating the difference between the neighboring frames in succession, the normal operation of MPEG cannot be expected if a train of uncorrelated video images from different channels of cameras is inevitably applied in succession.

As a consequence, the data compression rate becomes poor due to the fact that the correlation of the image frames in succession is not high enough for efficient data compression from different channels of DVR cameras.

Therefore, in case when multi-channel monitors are employed for the security and surveillance system, the prior art for the MPEG scheme loses its advantages and becomes like JPEG because the data compression disappears due to the poor correlation between the frames in succession.

Furthermore, it is also inefficient to furnish the multi-channel DVR system with MPEG chips as many as the number of the channels because of the rise in manufacturing cost.

### SUMMARY OF THE INVENTION

Accordingly, it is an object of the present invention to provide an apparatus and method of video image compression for multi-cannel moving pictures.

It is further an object of the present invention to provide an apparatus and method of video image compression with maximum compression rate even with a single MPEG processor for multi-channel moving pictures.

It is another object of the present invention to provide an apparatus and method of video image compression for multi-channel moving pictures with a single MPEG processor multiplexing each channel for estimating the correlation between the frames in succession.

Yet it is another object of the present invention to provide an apparatus and method of video image compression for multi-channel moving pictures transmitted from a multiple of DVR cameras for the security and surveillance system with a single MPEG processor multiplexing each channel.

In accordance with a broad aspect of the present invention, provided is a multi-channel image compression unit for moving pictures comprising a video switch that takes multiple channels of moving picture frame under the control of a control logic; a video decoder converting the moving picture frame, multiplexed from the multiple channels through said video switch, into a digital video signal; a control logic controlling the input sequence of the moving picture frame applied at said video switch, the frame selection, and the number of frames per second applied at the input of an MPEG processor; a video memory storing multiplexed moving picture frames from multi-channels; an MPEG processor taking an instruction from said video memory about the predefined number of frame per second (fps) under the control of logic, compressing the moving picture data by comparing the present frame with reference to the channel-dependent reference frame through taking over the video channel information for each frame from said control logic; a first memory storing the reference frame for each channel; and a second memory storing frame parameters for data compression of each moving picture frame of each video cannel.

### BRIEF DESCRIPTION OF THE DRAWINGS

Further feature of the present invention will become apparent from a description of a method and apparatus for video data compression for multi-channel DVR system taken in conjunction with the accompanying drawings of the preferred embodiment of the invention, which however, should not be taken to be limitative to the invention, but are for explanation and understanding only.

In the drawings:

FIG. 1 is a schematic diagram illustrating a constituting block for data compression of multi-channel moving pictures as a preferred embodiment in accordance with the present invention.

FIG. 2 is a schematic diagram illustrating the structure of the buffer memory for the reference image in accordance with the present invention.

FIG. 3 is a schematic diagram illustrating the constitution of the video image capture memory in accordance with the present invention.

### DETAILED DESCRIPTION OF THE PREFERRED EMBODIMENT OF THE INVENTION

The present invention will be explained in detail with reference to the accompanying drawings.

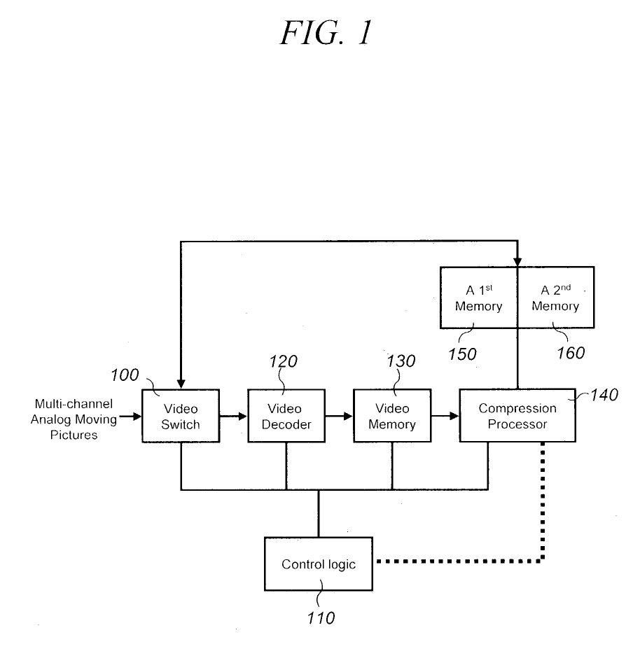

FIG. 1 is a schematic diagram illustrating the constitutional block for the data compression of the multi-channel moving pictures in accordance with the present invention. Referring to FIG. 1, video switches 100 as many as the number of video image inputs should be prepared in order to selectively take the video signal from a multiple (n) of channels.

A video switch 100 that is under the control of control logic 110 multiplexes the frames of the multi-channel analog moving picture, and the multiplexed image frames from the multi-channels are then applied to the input of the video decoder 120.

As a preferred embodiment in accordance with the present invention, the control logic 110 should be able to figure out which channel the present image frame entering the input of the video decoder 120 is from.

Preferably, a couple of video decoders 120 can be employed in order to maintain the maximum compression rate (30 fps) of the MPEG processor 140 even if every frame from the multiple channels is multiplexed.

As a preferred embodiment in accordance with the present invention, the input sequence of video images and/or the frame selection can be controlled by control logic 110, and the maximum performance can be guaranteed by employing a video memory 130 that ensures video data of 30 fps.

As a preferred embodiment for the processor 140 compressing the moving picture, an MPEG chip can be utilized. In the followings, the subject matter of the present invention will be explained with an MPEG chip as an embodiment.

It has been already pointed out that it is inefficient to compress the video data through the MPEG algorithm if the video images from different channels are mixed up.

Therefore, control logic 110 in accordance with the present invention provides the compression processor 140 with the information about the frame parameters corresponding to each frame. The compression processor 140 is then able to distinguish each channel and compresses the frame with the correct reference frame for each channel.

Thereafter, when the compressed image data for each channel is transferred to the main processor (not shown), the channel information is also given in order to make it possible to separately store the compressed data for each channel.

The present invention discloses a scheme wherein only one MPEG chip 140 is employed for data compression of multi-channel video images while the memories 150 and 160 for storing the reference image and frame parameters are prepared as many as the number of channels in a separate manner.

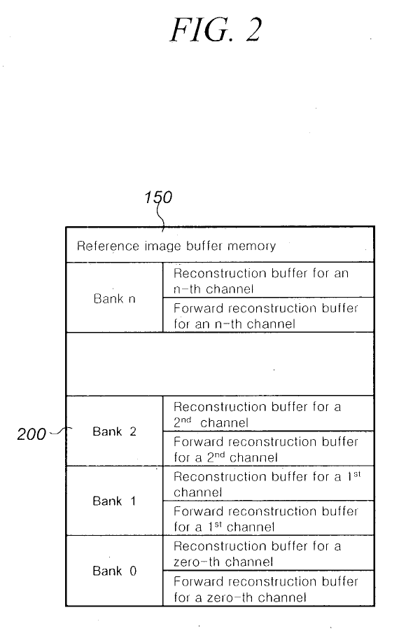

FIG. 2 is a schematic diagram illustrating the structure of the buffer memory for the reference image. Referring to FIG. 2, the buffer memory for the reference image 150, which is also called as a first memory in claim 1, has memory banks 200 as many as the number of channels.

In addition, both the reconstruction buffer and the forward reconstruction buffer are assigned for each channel in order to process the MPEG data stream for each channel. In this case, a backward reconstruction buffer is also needed for processing the B frame.

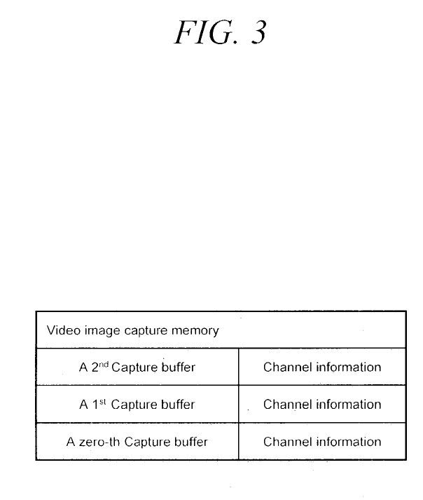

FIG. 3 is a schematic diagram illustrating the constitution of the capture memory for video image as an embodiment in accordance with the present invention. Referring to FIG. 3, it should be noted that the capture memory is not assigned to each channel.

Instead, only a certain number of capture memories (for instance, three) are prepared and they are used for the common capture buffer. The common capture buffer can be employed as a type of ring buffer in time sequence in an effort to minimize the memory requirement.

Referring to FIG. 1 again, a moving picture compression processor 140 takes the channel information of the current video image frame from the control logic 110 during the time when the image frame is taken, and thereby recognizes the image channel information of the capture buffer.

Further, the compression processor 140 processes the MPEG stream by referring to the memory bank 150, 160 for each channel at the instant of MPEG encoding process.

Furthermore, the transfer of the MPEG encoded data to the main processor is performed after the request of the moving picture compression processor 140 wherein the channel information or the accompanying frame parameters should be recognized beforehand for the MPEG encoded data at stand by.

Thereafter, the MPEG encoded data is processed and stored for each channel. As a preferred embodiment in accordance with the present invention, either one or more than one buffer memory can be employed for the MPEG encoding data buffer in consideration of the data transmission speed and other processing capability of the system.

Although the invention has been illustrated and described with respect to exemplary embodiments thereof, it should be understood by those skilled in the art that various other changes, omissions and additions may be made therein and thereto, without departing from the spirit and scope of the present invention.

Therefore, the present invention should not be understood as limited to the specific embodiment set forth above but to include all possible embodiments which can be embodies within a scope encompassed and equivalents thereof with respect to the feature set forth in the appended claims.

### INDUSTRIAL APPLICABILITY

The present invention makes it possible to implement multi-channel digital video recorders with only one MPEG chip for the maximum data compression rate, and, if needed, more than 2 to 32 channels are also to be implemented.

Since the DVR for the security and surveillance system requires the efficient processing for multiple cameras rather than the maintenance of 30 fps for each camera, the reduced frame per second (for instance, 3.5 fps) or each camera is acceptable with only a single MPEG chip for processing as many as 8 cameras.

In addition, since the moving picture data compression technique in accordance with the present invention makes it possible to adjust the number of frame per second for each camera, it is possible that 30 fps is maintained for an important location or situation while 15 fps is maintained otherwise for efficiency.

Furthermore, the present invention makes it possible to process a multiple number of cameras and to implement a cost-effective DVR system that can adjust the compression rate in accordance with a specific cannel.

What is claimed is:

1. An apparatus of compressing the data size of moving pictures for multi-channel digital video recorders (DVRs), comprising:
a video switch selectively taking the image frames of moving pictures from each of the multiple channels under the control of a control logic;
a video decoder converting the image frame from the output of said video switch to a digital video signal through multiplexing the image frames of the moving picture from channels;
a control logic controlling the input sequence of the moving picture for the video switch, the frame selection, and the number of the frame per second for a compression processor for moving pictures;
a video memory storing the image frame of moving pictures multiplexed and mixed-up for the multi-channels;
a compression processor for moving pictures taking a predefined number of frames per second from said video memory under the control of said control logic, compressing the video data through comparing the present frame with the channel-dependent reference frame together with the channel information taken from said control logic;
a first memory storing said channel-dependent reference frame for the compression of video data for each channel; and
a second memory storing frame parameters for moving pictures for each channel.

2. The apparatus as set forth in claim 1 wherein said first memory comprises a reconstruction buffer and a forward reconstruction buffer assigned for each channel for MPEG processing.

3. The apparatus as set forth in claim 1 wherein said video memory is not assigned for each channel, and is implemented as a ring buffer shared in time sequence.

4. The apparatus as set forth in claim 1 wherein said video decoder is implemented with multiple units in such a way that the number of frame per second is maintained to a predefined number.

5. The apparatus as set forth in claim 1 wherein said compression processor comprises one that compresses the video data through MPEG algorithm.

6. A method of compressing data size of moving pictures for multi-channel digital video recorders, comprising steps of:
(a) multiplexing the image frames of moving pictures transmitted from each of multiple channels through a video switch, and decoding the image frames into digital video signals;
(b) reading out the channel information for each image frame by accessing the digital video data corresponding to the predefined amount of frames per second at the video memory where the decoded data at the step (a) is stored; and
(c) compressing the video data independently for each channel by processing the digital video data accessed from the video memory in accordance with the channel information and the channel-dependent reference information with frame parameters.

7. The method as set forth in claim 6 wherein said step (c) comprises a step of compressing the video image frame by estimating the correlation for each channel between the current image frame and the channel-dependent reference frame through the access of the reconstruction buffer and the forward reconstruction buffer assigned fro each channel.

8. A method of compressing the data size of multiple-channel moving pictures with a single compression processor, comprising steps of:
(a) decoding each image frame of moving pictures into a digital video signal by multiplexing a series of image frames from each of multiple channels through selectively converting switch;
(b) storing the decoded data of step (a) at a video memory;
(c) requesting the video memory for the transmittal of the predefined amount of frames per second, and reading out the channel information corresponding to the transmitted image frame; and
(d) compressing the image data from the correlation between the current image frame and the reference frame corresponding to the channel of the current image frame by accessing the channel reference frame at a first memory and parameter information at a second memory.
